(19) United States
(12) Patent Application Publication
(10) Pub. No.: US 2006/0053962 A1
(43) Pub. Date: Mar. 16, 2006

(54) Retainer of spindle tube device

(76) Inventor: Douglas Chiang, Taichung Hsien (TW)

Correspondence Address: DOUGLAS CHIANG, 235 CHUNG-HO BOX 8-24, TAIPEI HSIEN, 235, TW

(21) Appl. No.: 10/899,434

(22) Filed: Jul. 26, 2004

(51) Int. Cl. G05G 1/14

(52) U.S. Cl. 74/594.1

(57) ABSTRACT

A retainer assembly of a spindle tube device comprises: a crank having a through hole; a spindle tube connected to the crank through a washer; the spindle tube being inserted into the through hole of the crank; a teeth portion being formed at an inner wall of the through hole, but not at end portions near outer edges of the inner wall of the through hole; one of the end portion of the inner wall of the through hole being installed with a washer groove for receiving the washer; a diameter of the washer groove being slightly larger than that of the teeth portion; a teethed protrusion being formed at one end portion of an outer wall of the spindle tube; the teethed protrusion capable of being coupled to the teeth portion of the through hole. After assembly, the teethed protrusion is engaged to the teeth portion.

### FIELD OF THE INVENTION

The present invention relates to spindles, and particularly to a retainer assembly of a spindle tube device.

### BACKGROUND OF THE INVENTION

For a bicycle, the spindle tube is firmly inserted into a through hole of a crank. However the prior art has the following disadvantages. The spindle tube has a gear and the through hole has ratchet teeth capable of being engaged to the gear.

The spindle tube is possible shifted as it is inserted into the through hole of the crank. However the gear and ratchet teeth have errors in manufacturing process so that the spindle tube cannot be well engaged to the crank or the spindle tube is not vertical to the crank. Thus, the user will apply a great force to the treadle and the force cannot be effectively transferred to the treadle. Moreover, for a longer time, the spindle tube and crank will be destroyed.

### SUMMARY OF THE INVENTION

Accordingly, the primary object of the present invention is to provide a retainer assembly of a spindle tube device, wherein a washer is engaged between the spindle tube and the crank so that the spindle tube is tightly engaged to the crank and the crank is vertical to the spindle tube. Thereby the force from the user can be effectively transferred to the treadle. Furthermore, the structure of the present invention is easy so that the cost is low and the present invention can be assembled easily.

To achieve above objects, the present invention provides a retainer assembly of a spindle tube device which comprises: a crank having a through hole; a spindle tube connected to the crank through a washer; the spindle tube being inserted into the through hole of the crank; a teeth portion being formed at an inner wall of the through hole, but not at end portions near outer edges of the inner wall of the through hole; one of the end portion of the inner wall of the through hole being installed with a washer groove for receiving the washer; a diameter of the washer groove being slightly larger than that of the teeth portion; a teethed protrusion being formed at one end portion of an outer wall of the spindle tube; the teethed protrusion capable of being coupled to the teeth portion of the through hole; thereby when the spindle tube is inserted into the through hole, the teethed protrusion is engaged to the teeth portion. After the spindle tube is inserted into the through hole, the washer is placed in the washer groove and the crank is vertical to the spindle tube.

The various objects and advantages of the present invention will be more readily understood from the following detailed description when read in conjunction with the appended drawing.

### BRIEF DESCRIPTION OF THE DRAWINGS

FIG. 1 is an exploded view of the retainer assembly of a spindle tube device of the present invention.

FIG. 2 is a schematic view of the retainer assembly of a spindle tube device of the present invention.

FIG. 3 is a cross sectional view showing the operation of the retainer assembly of a spindle tube device of the present invention.

FIG. 4 is another schematic view showing the operation of the retaining magnetic block of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

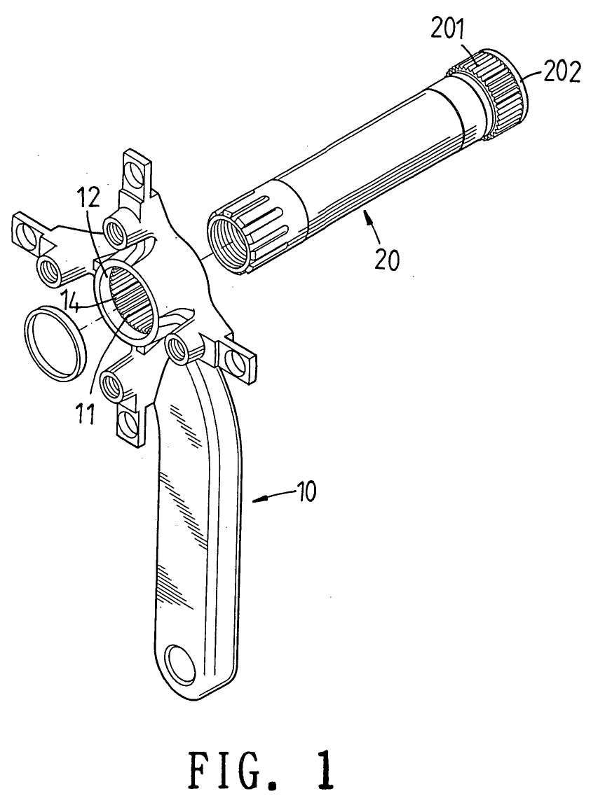

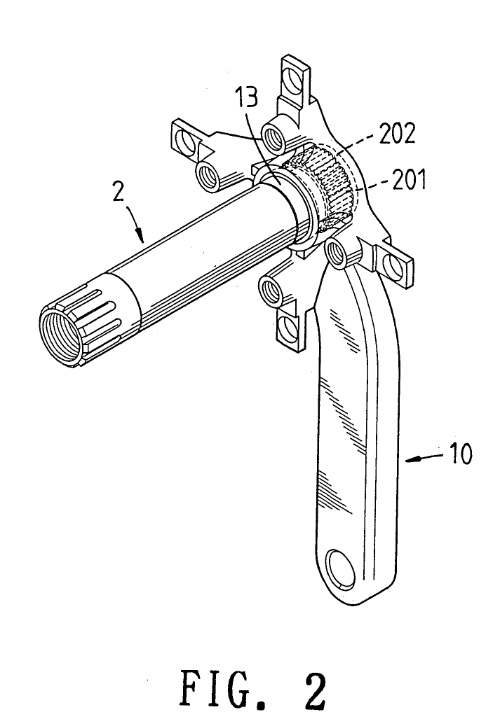

Referring to FIGS. 1 and 2, the retainer assembly of a spindle tube device of the present invention is illustrated. The retainer assembly of a spindle tube device has the following elements.

A crank 10 can be connected to a bicycle body and a treadle of the bicycle. The crank 10 has a through hole 11.

A spindle tube 20 is connected to the crank 10 through a washer 13. The spindle tube 20 is inserted into the through hole 11 of the crank 10. A teeth portion 14 is formed at an inner wall of the through hole 11, but not at end portions near outer edges of the inner wall of the through hole 11. One of the end portion of the inner wall of the through hole 11 is formed with a washer groove 12 for receiving the washer 13. A diameter of the washer groove 12 is slightly larger than that of the teeth portion 14.

A teethed protrusion 202 is protruded from one end portion of an outer wall of the spindle tube 20. The teethed protrusion 202 capable of being coupled to the teeth portion 14 of the through hole 11. That is, they have the same number of teeth and have the same slope for each pair of correspondent teeth. Thereby when the spindle tube 20 is inserted into the through hole 11, the teethed protrusion 202 is engaged to the teeth portion 14.

An outer side of the teethed protrusion 202 is extended with a stop edge 202. A diameter of the stop edge 202 is identical to an inner diameter of the through hole 11 of the crank 10. When the spindle tube 20 is inserted into the through hole 11. Other than the teethed protrusion 202 is engaged to the teeth portion 14, the stop edge 202 serves to tightly engage to a distal end of the through hole 11 so that the spindle tube 20 is firmly secured to the crank 10.

The washer 13 is installed at another end of the spindle tube 20 other than the end having the teethed protrusion 202. The washer 13 is received in the washer groove 12. Thereby when the spindle tube 20 is connected to a crank, the spindle tube 20 can be fixed with a desired orientation so that the crank 10 is vertical to the spindle tube 20.

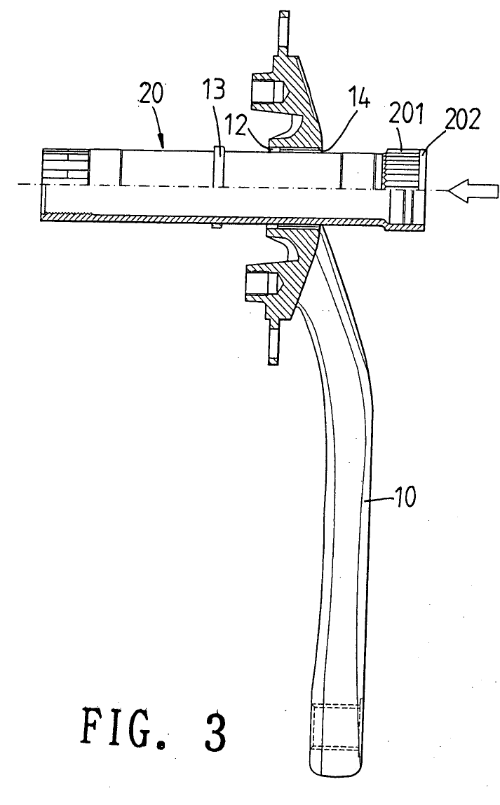

Referring to FIG. 3, in use of the present invention, the spindle tube 20 is horizontally installed into the through hole 11 of the crank 10. Meanwhile, the washer 13 is placed in the washer groove 12 so that the spindle tube 20 is firmly secured to the crank 10 because the tightening engagement of the teethed protrusion 202 and the teeth portion 14 and the stop edge 202 of the spindle tube 20 is fixed to an outer side of the through hole 11.

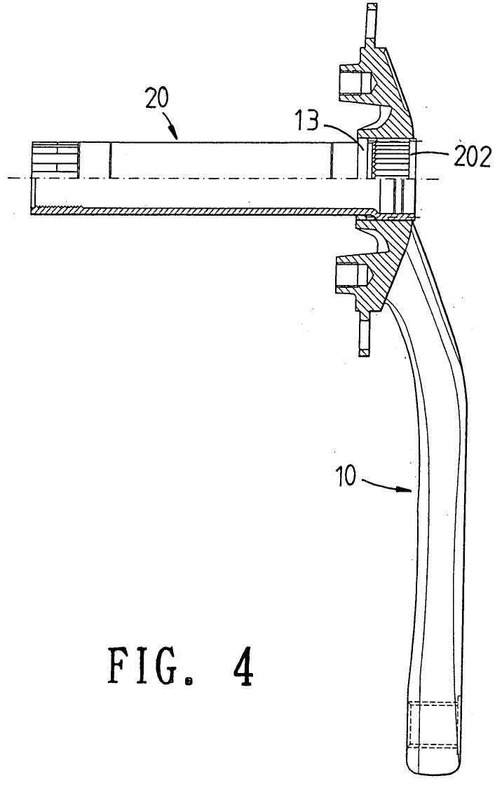

Furthermore, in the present invention, when the spindle tube 20 is inserted into the through hole 11, as shown in FIG. 4, the washer 13 has the effect to make the spindle tube 20 is tightly and vertically engaged to the crank 10 so that when the spindle tube 20 is assembled to a bicycle body, the force is effectively applied to the treadle and the washer 13 has the effect of compensating the error in the manufacturing of the teeth portion 14 and the teethed protrusion 202. Thereby the user can easily apply an force to the treadle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A retainer assembly of a spindle tube device comprises:
a crank having a through hole;
a spindle tube connected to the crank through a washer; the spindle tube being inserted into the through hole of the crank; a teeth portion being formed at an inner wall of the through hole, but not at end portions near outer edges of the inner wall of the through hole; one of the end portion of the inner wall of the through hole being installed with a washer groove for receiving the washer; a diameter of the washer groove being slightly larger than that of the teeth portion;
a teethed protrusion being formed at one end portion of an outer wall of the spindle tube; the teethed protrusion capable of being coupled to the teeth portion of the through hole; thereby when the spindle tube is inserted into the through hole, the teethed protrusion is engaged to the teeth portion;
wherein after the spindle tube is inserted into the through hole, the washer is placed in the washer groove and the crank is vertical to the spindle tube.

2. The retainer assembly of a spindle tube device as claimed in claim 1, wherein the teethed protrusion is slightly protruded from the outer wall of the spindle tube

3. The retainer assembly of a spindle tube device as claimed in claim 1, wherein an outer side of the teethed protrusion is extended with a stop edge.
